(19) United States
(12) Patent Application Publication
(10) Pub. No.: US 2017/0233608 A1
(43) Pub. Date: Aug. 17, 2017

(54) Streakless Car Polish

(71) Applicants: Christopher J. Siciliano, Revere, MA (US); Gerald A. Holmes, Wall Township, NJ (US)

(72) Inventors: Christopher J. Siciliano, Revere, MA (US); Gerald A. Holmes, Wall Township, NJ (US)

(21) Appl. No.: 15/433,635

(22) Filed: Feb. 15, 2017

Related U.S. Application Data
(60) Provisional application No. 62/296,276, filed on Feb. 17, 2016.

(51) Int. Cl. C09G 1/16; B05D 5/00; B05D 3/00; B05D 7/16; B05D 1/02

(52) U.S. Cl. CPC C09G 1/16; B05D 7/16; B05D 1/02; B05D 3/007; B05D 5/00

(57) ABSTRACT

A streakless car polish formulation can be applied easily, by the car owner or in a commercial setting, and does not leave any objectionable residue after application. The formulation involves a silicone emulsion and a fluorosurfactant carried in aqueous solution of alcohol and water, and may include a minor amount of sodium benzoate. The product increases the hydrophilicity of automotive painted or glass surfaces, so that water does not bead up.

Applicants claim priority under 35 U.S.C. 119(e) of copending U.S. Provisional Application Ser. No. 62/296,276, filed Feb. 17, 2016.

### BACKGROUND OF THE INVENTION

This invention concerns a spray-on car polish or wax. The invention is more particularly concerned with a spray-on formulation that resolves the problem of having to buff out the wax or polish after application, yet leaving the car's finish streak-free.

The inventions is more specifically directed to a car polish or wax product that may be sprayed onto the car using either a pressurized or aerosol sprayer or a pump sprayer. Favorably, after application the liquid is wiped away, leaving a streak-free finish, without having to buff out any spots.

### OBJECTS AND SUMMARY OF THE INVENTION

It is an object to provide a streakless car polish formulation that may be applied easily by the car owner or in a commercial setting, and which does not leave any objectionable residue after application.

According to this invention, the formulation of the product involves a silicone emulsion and a fluorosurfactant carried in a solution of alcohol and water. The product increases the hydrophilicity of the automotive painted or glass surfaces, so that water does not bead up on it.

In one favorable formulation, the composition employs 28.5 grams of a fluorosurfactant (Capstone FS-63), and 5.0 grams of silicone emulsion (Xiameter MEM-1101), a small amount (0.10 grams) sodium benzoate, and the water-alcohol solution to make up to 500 grams total weight. The percentages by weight can be Ethanol—8 to 12%; Water—80 to 85%; Silicone Emulsion—4 to 7%; Silicone Emulsion—0.5 to 2.0%; (optional) Sodium Benzoate 0.01 to 0.05%. Percentages of active ingredients are Silicone Emulsion, 0.25% to 1.0%; Fluorosurfactant, 2% to 10%; and Sodium Benzoate, 0.02% to 0.05%.

The inventors have found that the amounts in the formulations as disclosed here may be varied by about ±5% and still achieve the desired benefits.

### DETAILED DISCLOSURE

The composition of this invention can be embodied in a number of formulations, varying the relative amounts of ingredients, and may vary the specific silicone emulsion and/or fluorosurfactant over a range of specifics.

In a first example, the composition may be formulated as follows:

| | | | % active |
|---|---|---|---|
| Material | Weight | % of formula | (by weight) |
| Ethanol (99%) | 50 grams | 10.00% | N/A |
| Water | 416 g. | 83.3 | N/A |
| Capstone FS-63 | 28.5 g. | 5.7 | 2.00% |
| Xiameter MEM-1101 | 5.0 g. | 1.0 | 0.50% |
| Sodium Benzoate | 0.10 g. | 0.02 | 0.02% |
| Totals: | 499+ g. | | 2.52% |

A second formulation can be formulated as follows:

| | | | % active |
|---|---|---|---|
| Material | Weight | % of formula | (by weight) |
| Water (distilled) | 420 grams | 95.89% | |
| Xiameter MEM-1101 | 16 g. | 3.65 | 1.82% |
| Kaopolite SF | 2 g. | 0.45 | |
| Totals: | 438 grams | | 1.82% |

A third formulation can be as follows:

| | | | % active |
|---|---|---|---|
| Material | Weight | % of formula | (by weight) |
| Ethanol (99%) | 50 grams | 10.05 | N/A |
| Water (distilled) | 416 g. | 83.8 | N/A |
| Capstone FS-63 | 28.5 g. | 5.7 | 2.00% |
| Xiameter MEM-1101 | 2.5 g. | 0.50 | 0.50% |
| Sodium Benzoate | 0.10 g. | 0.02 | 0.02% |
| Totals: | 497+ g. | | 2.27% |

A fourth formulation can be as follows:

| | | | % active |
|---|---|---|---|
| Material | Weight | % of formula | (by weight) |
| Ethanol (99%) | 50 grams | 10.35 | N/A |
| Water (distilled) | 416 g. | 86.15 | N/A |
| Capstone FS-63 | 14.25 g. | 2.95 | 2.00% |
| Xiameter MEM-1101 | 2.5 g. | 0.51 | 0.25% |
| Sodium Benzoate | 0.10 g. | 0.02 | 0.02% |
| Totals: | 483− g. | | 1.27% |

A fifth formulation can be as follows:

| | | | | % active |
|---|---|---|---|---|
| Material | Weight | | % of formula | (by weight) |
| Ethanol (99%) | 50 | grams | 10.08 | N/A |
| Water (distilled) | 416 | g. | 83.89 | N/A |
| Capstone FS-63 | 28.5 | g. | 5.74 | 2.00% |
| Xiameter MEM-1101 | 1.25 | | 0.25 | 0.13 |
| Sodium Benzoate | 0.10 | g. | 0.02 | 0.02% |
| Totals: | 485.95 | g. | | 2.15% |

A sixth formulation may be as follows:

| | | | | % active |
|---|---|---|---|---|
| Material | Weight | | % of formula | (by weight) |
| Ethanol (99%+) | 50 | grams | 10.28 | N/A |
| Water (distilled) | 416 | g. | 85.60 | N/A |
| Capstone FS-63 | 17.35 | g. | 3.57 | 1.25% |
| Xiameter MEM-1101 | 2.5 | g. | 0.51 | 0.25% |
| Sodium Benzoate | 0.10 | g. | 0.02 | 0.02% |
| Totals: | 485.95 | g. | | 1.27% |

A seventh formulation can be as follows:

| | | | | % active |
|---|---|---|---|---|
| Material | Weight | | % of formula | (by weight) |
| Ethanol (99%+) | 50.5 | grams | 10.40 | N/A |
| Water (distilled) | 426 | g. | 87.74 | N/A |
| Capstone FS-63 | 6.25 | g. | 1.29 | 0.45% |
| Xiameter MEM-1101 | 2.5 | g. | 0.51 | 0.25% |
| Sodium Benzoate | 0.10 | g. | 0.02 | 0.02% |
| Totals: | 485.35 | g. | | 0.72% |

An eighth formulation can be as follows:

| | | | | % active |
|---|---|---|---|---|
| Material | Weight | | % of formula | (by weight) |
| Ethanol (99%+) | 29.1 | grams | 6.00 | N/A |
| Water (distilled) | 499.5 | g. | 92.60 | N/A |
| Capstone FS-63 | 2.78 | g. | 0.57 | 0.20% |
| Xiameter MEM-1101 | 3.90 | g. | 0.80 | 0.40% |
| Sodium Benzoate | 0.10 | g. | 0.02 | 0.02% |
| Totals: | 485.38 | g. | | 0.62% |

A ninth formulation can be as follows:

| | | | | % active |
|---|---|---|---|---|
| Material | Weight | | % of formula | (by weight) |
| Ethanol (99%+) | 519.61 | grams | 6.00 | N/A |
| Water (distilled) | 8061 | g. | 93.00 | N/A |
| Capstone FS-63 | 49.64 | g. | 0.57 | 0.20% |
| Xiameter MEM-1101 | 34.67 | | 0.40 | 0.20% |
| Sodium Benzoate | 1.78 | g. | 0.02 | 0.02% |
| Totals: | 8667 | g. | | 0.42% |

A tenth formulation can be as follows:

| | | | | % active |
|---|---|---|---|---|
| Material | Weight | | % of formula | (by weight) |
| Ethanol (99%+) | 529.90 | grams | 6.00 | N/A |
| Water (distilled) | 8094.73 | g. | 93.39 | N/A |
| Capstone FS-63 | 29.78 | g. | 0.34 | 0.12% |
| Xiameter MEM-1101 | 20.80 | g. | 0.24 | 0.12% |
| Sodium Benzoate | 1178 | g. | 0.02 | 0.02% |
| Totals: | 8667 | g. | | 0.26% |

Testing has shown superior performance for the silicone emulsion at about 0.50% by weight and active fluorosurfactant at about 2.00%, by weight in aqueous solution, preferably with ethanol or another alcohol present at about 10%.

In each example, the amounts of each ingredient in these formulations may be varied (up or down) by about 5% and still achieve satisfactory results.

The formulation is applied by spraying it onto the clean vehicle and allowing it to dry, then wiping off any wet regions, as needed. The water dries without beading, leaving the surface essentially spotless.

Specific available products were used as mentioned above, namely Capstone FS-63 as fluorosurfactant and Xiameter MEM-1101 as silicone emulsion. However, other available products could be used in their place. Products with very similar characteristics may be made using Capstone FS-60, Capstone FS-61, Capstone FS-64, Capstone FS-65, Capstone FS-34, or Capstone FS-35, or any other water-soluble, anionic fluorosurfactant that creates a low aqueous surface tension, with minimal foaming.

Many modifications and variations are possible without departing from the scope and spirit of this invention.

What is claimed is:

1. A liquid formulation for use as a streak-free spray-on car polish, comprising a fluorosurfactant present at about 2% by weight, a silicone emulsion present at about 0.5% by weight, and the balance being water and up to a minor portion of alcohol.

2. The formulation of claim 1 including a minor amount of sodium benzoate.

3. The formulation of claim 1 wherein the formulation is in the form of an aerosol or spray.

4. The formulation of claim 1, formulated as follows:

| Material | % of formula | % active (by weight) |
|---|---|---|
| Ethanol (99%) | 10.00% | N/A |
| Water | 83.3 | N/A |
| fluorosurfactant | 5.7 | 2.00% |
| silicone emulsion | 1.0 | 0.50% |
| Sodium Benzoate | 0.02 | 0.02% |
| Totals: | | 2.52% |

4. The formulation of claim 1, formulated as follows:

| Material | % of formula | % active (by weight) |
|---|---|---|
| Water (distilled) | 95.89% | |
| fluorosurfactant | 3.65 | 1.82% |
| silicone emulsion | 0.45 | |
| Totals: | | 1.82% |

5. The formulation of claim 1, formulated as follows:

| Material | % of formula | % active (by weight) |
|---|---|---|
| Ethanol (99%) | 10.05 | N/A |
| Water (distilled) | 83.8 | N/A |
| fluorosurfactant | 5.7 | 2.00% |
| silicone emulsion | 0.50 | 0.50% |
| Sodium Benzoate | 0.02 | 0.02% |
| Totals: | | 2.27% |

6. The formulation of claim 1, formulated as follows:

| Material | % of formula | % active (by weight) |
|---|---|---|
| Ethanol (99%) | 10.35 | N/A |
| Water (distilled) | 86.15 | N/A |
| fluorosurfactant | 2.95 | 2.00% |
| silicone emulsion | 0.51 | 0.25% |
| Sodium Benzoate | 0.02 | 0.02% |
| Totals: | | 1.27% |

7. The formulation of claim 1, formulated as follows:

| Material | % of formula | % active (by weight) |
|---|---|---|
| Ethanol (99%) | 10.08 | N/A |
| Water (distilled) | 83.89 | N/A |
| fluorosurfactant | 5.74 | 2.00% |
| silicone emulsion | 0.25 | 0.13 |
| Sodium Benzoate | 0.02 | 0.02% |
| Totals: | | 2.15% |

8. The formulation of claim 1, formulated as follows:

| Material | % of formula | % active (by weight) |
|---|---|---|
| Ethanol (99%+) | 10.28 | N/A |
| Water (distilled) | 85.60 | N/A |
| fluorosurfactant | 3.57 | 1.25% |
| silicone emulsion | 0.51 | 0.25% |
| Sodium Benzoate | 0.02 | 0.02% |
| Totals: | | 1.27% |

9. The formulation of claim 1, formulated as follows:

| Material | % of formula | % active (by weight) |
|---|---|---|
| Ethanol (99%+) | 10.40 | N/A |
| Water (distilled) | 87.74 | N/A |
| fluorosurfactant | 1.29 | 0.45% |
| silicone emulsion | 0.51 | 0.25% |
| Sodium Benzoate | 0.02 | 0.02% |
| Totals: | | 0.72% |

10. The formulation of claim 1, formulated as follows:

| Material | % of formula | % active (by weight) |
|---|---|---|
| Ethanol (99%+) | 6.00 | N/A |
| Water (distilled) | 92.60 | N/A |
| fluorosurfactant | 0.57 | 0.20% |
| silicone emulsion | 0.80 | 0.40% |
| Sodium Benzoate | 0.02 | 0.02% |
| Totals: | | 0.62% |

11. The formulation of claim 1, formulated as follows:

| Material | % of formula | % active (by weight) |
|---|---|---|
| Ethanol (99%+) | 6.00 | N/A |
| Water (distilled) | 93.39 | N/A |
| fluorosurfactant | 0.34 | 0.12% |
| silicone emulsion | 0.24 | 0.12% |
| Sodium Benzoate | 0.02 | 0.02% |
| Totals: | | 0.26% |

12. A method of creating a streakless finish on an automobile comprising
a. preparing an aqueous formulation of a fluorosurfactant present at about 2% by weight, a silicone emulsion present at about 0.5% by weight, and the balance substantially a solution of alcohol and water;
b. spraying the aqueous formulation onto the finish of the automobile; and
c. permitting the formulation to dry.
